(19) United States
(12) Patent Application Publication
(10) Pub. No.: US 2005/0233069 A1
(43) Pub. Date: Oct. 20, 2005

(54) Antiglare film

(75) Inventors: Koichi Mikami, Tokyo-To (JP); Yukimitsu Iwata, Tokyo-To (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 10/992,598

(22) Filed: Nov. 18, 2004

(30) Foreign Application Priority Data
Nov. 25, 2003 (JP) 2003-393585

(51) Int. Cl. B05B 5/00

(52) U.S. Cl. 427/160

(57) ABSTRACT

The invention is provided an antiglare film with a reduced tendency for curling and scratch resistance imparted thereto. The antiglare film comprises a substrate and an antiglare layer provided on the substrate. The antiglare layer comprises fine particles and two or more polyfunctional acrylic resins. At least one of the two or more polyfunctional acrylic resins is isocyanurate ethoxy-modified diacrylate represented by a specific formula.

### TECHNICAL FIELD

The present invention relates to an antiglare film for use in displays such as CRTs and liquid crystal panels, and an antireflection film and an image display device using the same.

### BACKGROUND ART

Displays such as liquid crystal panels are provided with an antiglare film, an antireflection film or the like and utilized for regulating light emitted from a light source. In the formation of these films, heat curable resins, especially acrylic acid resins, are utilized for protecting the films per se, particularly for imparting scratch resistance. In order to improve the mechanical strength of the hard coat layer, Japanese Patent Laid-Open No. 20103/1998 proposes exposure of an ionizing radiation curing resin or the like to an ionizing radiation for crosslinking curing to form a hard coat layer. Up to now, however, a combination of two or more resins which provide desired strength and can improve scratch resistance could not have been found in many acrylic acid resins.

On the other hand, in recent years, there is an ever-increasing demand for a reduction in thickness in displays used in cellular (portable) phones, small notebook computers and the like. In order to meet this demand, the present inventors have made an experiment in which a transparent substrate having a thickness which is half of the conventional thickness (100 to 70 μm) is coated with an antiglare agent-containing ionizing radiation curing resin or the like to form a coating which is then exposed to an ionizing radiation for crosslinking curing to form an antiglare layer. As a result, it was found that curling occurred in the antiglare layer. Accordingly, at the present time, the development of an antiglare film, which can suppress curling of an antiglare layer provided on a substrate and has improved scratch resistance, and an antireflection film using the antiglare film have been desired.

### SUMMARY OF THE INVENTION

The present inventors have now found that the utilization of isocyanurate ethoxy-modified diacrylate in combination with other polyfunctional acrylic resin can provide an antiglare film that can reduce a tendency for curling in the antiglare layer and has scratch resistance. The present invention has been made based on such finding.

Accordingly, an object of the present invention is to provide an antiglare film that can reduce a tendency for curling in the antiglare layer and has excellent scratch resistance.

According to the present invention, there is provided an antiglare film comprising: a substrate; and an antiglare layer provided on said substrate,

said antiglare layer comprising fine particles and two or more polyfunctional acrylic resins,

at least one of said two or more polyfunctional acrylic resins being isocyanurate ethoxy-modified diacrylate represented by formula (I):

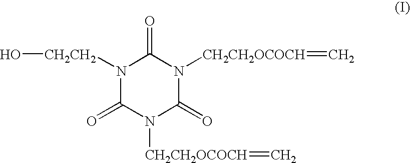

According to another aspect of the present invention, there is provided an antireflection film. This antireflection film comprises: a substrate, an antiglare layer, and a low refractive index layer, wherein

said low-refractive index layer has a lower refractive index than said antiglare layer, and is provided on the antiglare layer, and

said substrate and said antiglare layer constitute the above antiglare film according to the present invention.

### BRIEF DESCRIPTION OF THE DRAWING

FIG. 1 is a schematic diagram showing one embodiment of the antiglare film according to the present invention.

### DESCRIPTION OF REFERENCE CHARACTERS

1: antiglare film, 3: center point of antiglare layer, 4: peripheral part of antiglare layer, 5: antiglare layer, 7: curl width, and 9: transparent substrate.

### DETAILED DESCRIPTION OF THE INVENTION

Antiglare Film

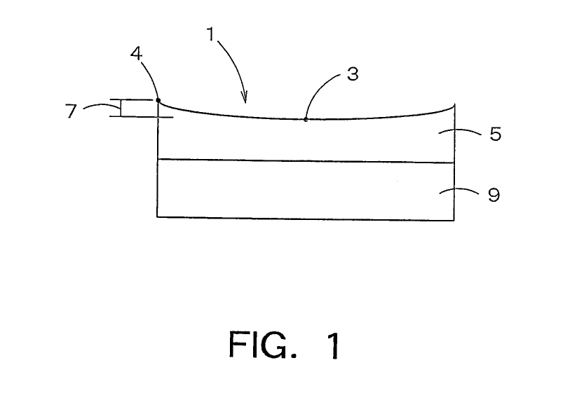

An embodiment of the antiglare film according to the present invention will be described with reference to FIG. 1. FIG. 1 is a cross-sectional view of an antiglare film 1 according to the present invention. An antiglare layer is provided on the upper surface of a substrate 9. The antiglare layer 5 is formed by coating a composition comprising fine particles, isocyanurate ethoxy-modified diacrylate represented by formula (I) as a polyfunctional acrylic resin, and pentaerythritol triacrylate as other polyfunctional acrylic resin onto the upper surface of the substrate 9 and exposing the coating to ultraviolet light.

The antiglare film according to the present invention can effectively prevent curling in the antiglare layer formed on the surface of the substrate and has excellent scratch resistance. Therefore, in the present invention, the difference in thickness 7 between the peripheral part 4 and the center part 3 in the antiglare layer 5 is most preferably 0 μm. However, from the viewpoint of technique, the difference in thickness 7 between the peripheral part 4 and the center part 3 in the antiglare layer is not more than 1.0 μm, preferably not more than 0.5 μm, more preferably 0.3 μm.

1) Polyfunctional Acrylic Resin

The antiglare layer according to the present invention comprises two or more polyfunctional acrylic resins. In the present invention, at least one of the two or more polyfunctional acrylic resins is isocyanurate ethoxy-modified diacrylate represented by formula (I). Specific examples of polyfunctional acrylic resins other than those represented by formula (I) include polymethylolpropane tri(meth)acrylate, hexanediol di(meth)acrylate (HDDA), tripropylene glycol di(meth)acrylate (TPGDA), diethylene glycol di(meth)acrylate (DEGDA), pentaerythritol [tri(meth)]acrylate (PETA), dipentaerythritol hexa(meth)acrylate (DPHA), and neopentyl glycol di(meth)acrylate (NPGDA). Preferred are the above-described PETA, DPHA, and HPDA. More preferred are pentaerythritol triacrylate [(CH₂═CHCOCOH₂)₃CCH₂OH].

The amount of the isocyanurate ethoxy-modified diacrylate represented by formula (I) added is not less than 10% by weight and not more than 45% by weight based on the total weight of the polyfunctional acrylic resin. Preferably, the upper limit of the addition amount is 40% by weight, and the lower limit of the addition amount is 20% by weight.

In a preferred embodiment of the present invention, a combination of an isocyanurate ethoxy-modified diacrylate represented by formula (I) with pentaerythritol triacrylate is preferably used.

In the present invention, the antiglare layer is formed of two or more polyfunctional acrylic resins. Further, other basic materials, for example, ionizing radiation curing compositions such as UV curable compounds, may also be added. In forming the antiglare layer, a photopolymerization initiator can be used, and specific examples thereof include 1-hydroxy-cyclohexyl-phenyl-ketone. This compound is commercially available, for example, from Ciba Specialty Chemicals, K.K. under the tradename Irgacure 184.

2) Antiglare Agent

Specific examples of antiglare agents include fine particles, preferably plastic beads, more preferably transparent plastic beads. Specific examples of plastic beads include styrene beads (refractive index 1.59), melamine beads (refractive index 1.57), acryl beads (refractive index 1.49), acryl-styrene beads (refractive index 1.54), polycarbonate beads, and polyethylene beads. Preferred plastic beads include styrene beads.

The particle diameter of the plastic beads is not less than 0.5 μm and not more than 15 μm. Preferably, the lower limit of the particle diameter is 3 μm, and the upper limit of the particle diameter is 6 μm. Particle diameters falling within the above-defined range are advantageous in that the light diffusing effect is high, satisfactory antiglare properties can be imparted, the internal haze value can be increased, and dazzling of images can be satisfactorily improved.

The amount of the plastic beads added is not less than 3% by weight and not more than 30% by weight based on the total weight of the antiglare layer. Preferably, the lower limit of the addition amount is 5% by weight, and the upper limit of the addition amount is 20% by weight. More preferably, the lower limit of the addition amount is 8% by weight, and the upper limit of the addition amount is 15% by weight. The addition amount falling within the above-defined range is advantageous in that the effect of diffusing light is high, the sharpness of the transmitted image is increased, and dazzling of images can be suppressed.

When plastic beads are added, inorganic fillers such as silica may be added. The addition of the inorganic filler can suppress the settling of plastic beads added to the resin component for forming the antiglare layer.

The particle diameter of the inorganic filler is preferably not less than 0.5 μm and not more than 5 μm. The amount of the inorganic filler added is not less than 3% by weight and not more than 30% by weight based on the total weight of the antiglare layer. Preferably, the upper limit of the addition amount is 15% by weight. When the particle diameter or addition amount of the inorganic filler falls within the above-defined range, settling of the plastic beads can be effectively prevented and, at the same time, the transparency of the antiglare layer can be ensured.

When the plastic beads or inorganic fillers have been added, a preferred method is to satisfactorily mix them with the resin component for constituting the antiglare layer to prepare a homogeneous dispersion which is then coated onto the transparent substrate.

In a preferred embodiment of the present invention, when the antiglare film according to the present invention comprises an antistatic layer which will be described later, preferably, the antiglare layer further comprises electrically conductive fine particles. This can impart electrical conductivity to a part between the antistatic layer and the outermost layer in the antiglare layer.

Specific examples of electrically conductive fine particles may be the same as those described below in connection with the antistatic layer.

3) Substrate

Preferably, the substrate is transparent, smooth, and resistant to heat and has excellent mechanical strength. Specific examples of the material for constituting the substrate include thermoplastic resins such as polyester, cellulose triacetate, cellulose diacetate, cellulose acetate butyrate, polyester, polyamide, polyimide, polyether sulfone, polysulfone, polypropylene, polymethyl pentene, polyvinyl chloride, polyvinyl acetal, polyether ketone, polymethyl methacrylate, polycarbonate, and polyurethane. Preferred are polyesters, and cellulose triacetate.

In the present invention, these thermoplastic resins are used as a thin, highly flexible film. Depending upon embodiments where curing properties are required, plates such as plates of thermoplastic resins or glass plates may also be used.

The thickness of the substrate is not less than 20 μm and not more than 300 μm. Preferably, the upper limit of the thickness is 200 μm, and the lower limit of the thickness is 30 μm. When the substrate is in a plate form, the thickness may exceed the above upper limit. In the formation of the antiglare layer on the substrate, the substrate may previously be subjected to physical treatment such as corona discharge treatment and oxidation treatment, or may previously be coated with a coating composition called an anchoring agent or a primer from the viewpoint of improving the adhesion.

4) Formation of Antiglare Layer

The antiglare layer may be formed by mixing the above two or more polyfunctional acrylic resins in a suitable solvent, for example, toluene, xylene, cyclohexane, ethyl acetate, butyl acetate, propyl acetate, MEK, and MIBK, to prepare a liquid composition which is then coated onto a substrate.

In a preferred embodiment of the present invention, a leveling agent, for example, a fluorine or silicone leveling agent, is added to the liquid composition. In the liquid composition with the leveling agent added thereto, upon coating or drying of the coating, the inhibition of curing by oxygen on the surface of the coating can be effectively prevented, and, at the same time, the anti-scratch effect can be imparted. The leveling agent is preferably utilized in transparent substrates in a film form where heat resistance is required (for example, triacetylcellulose).

Methods usable for coating the liquid composition include roll coating, Mayer-bar coating, and gravure coating. After coating of the liquid composition, drying and ultraviolet curing are carried out. Specific examples of ultraviolet light sources include light sources such as ultrahigh pressure mercury lamps, high pressure mercury lamps, low pressure mercury lamps, carbon arc lamps, blacklight fluorescent lamps, and metal halide lamps. The wavelength of the ultraviolet light may be in a wavelength range of 190 to 380 nm. Specific examples of electron beam sources include various electron beam accelerators, for example, Cockcroft-Walton, van de Graaff, resonance transformer, insulated core transformer, linear, dynamitron, and high-frequency electron beam accelerators.

The thickness of the antiglare layer is not less than 0.5 μm and not more than 10 μm. Preferably, the lower limit of the thickness of the antiglare layer is 1 μm, and the upper limit of the thickness of the antiglare layer is 7 μm.

Antistatic Layer (Electrically Conductive Layer)

In a preferred embodiment of the present invention, in the antiglare film, the antistatic layer (electrically conductively layer) may be formed between the substrate and the antiglare layer.

The antistatic layer (electrically conductive layer) is preferably formed on the upper surface of the antiglare layer. Specific examples of methods usable for forming an antistatic layer are one in which a vapor-deposited film is formed by vapor-depositing or sputtering an electrically conductive metal, an electrically conductive metal oxide or the like onto the upper surface of an antiglare layer, and one in which a coating is formed by coating a resin composition comprising electrically conductive fine particles dispersed in a resin. The antistatic layer is preferably formed so as to have a surface resistivity value of not more than 5×10⁷ Ω/□.

1) Antistatic Agent

When the antistatic layer is formed as a vapor-deposited film, electrically conductive metals or electrically conductive metal oxides, for example, antimony-doped indium tin oxide (hereinafter referred to as “ATO”) and indium tin oxide (hereinafter referred to as “ITO”), may be mentioned as the antistatic agent. The thickness of the vapor-deposited film as the antistatic layer is not less than 10 nm and not more than 200 nm. Preferably, the upper limit of the thickness is 100 nm, and the lower limit of the thickness is 50 nm.

The antistatic layer may be formed by using a coating liquid containing electrically conductive fine particles as an antistatic agent. Specific examples of electrically conductive fine particles include electrically conductive fine particles of a metal or a metal oxide or an organic compound, for example, fine particles of antimony-doped indium tin oxide (hereinafter referred to as “ATO”), indium tin oxide (hereinafter referred to as “ITO”), and organic compounds which had been surface treated with gold and/or nickel.

The amount of the electrically conductive fine particles added is not less than 5% by weight and not more than 70% by weight based on the total weight of the antistatic layer. Preferably, the upper limit of the addition amount is 60% by weight, and the lower limit of the addition amount is 15% by weight. The thickness of the coating is not less than 0.05 μm and not more than 2 μm. Preferably, the lower limit of the thickness of the coating is 0.1 μm, and the upper limit of the thickness of the coating is 1 μm.

2) Curing Resin

In the present invention, when a coating is formed by using electrically conductive fine particles, a curing resin is preferably used. Preferred curing resins are transparent. Three types of resins, that is, ionizing radiation curing resins which are curable by ultraviolet light or electron beam irradiation, mixtures of ionizing radiation curing resins with solvent drying type resins, and heat-curing resins, may be mentioned as specific examples of this resin. Preferred are ionizing radiation curing resins.

a) Ionizing Radiation Curing Resin

Specific examples of ionizing radiation curing resins may be the same as those described above in connection with the polyfunctional acrylic resin.

When the ionizing radiation curing resin is used as the ultraviolet curing resin, the use of a photopolymerization initiator is preferred. Specific examples of photopolymerization initiators include acetophenones, benzophenones, Michler's benzoyl benzoate, α-amyloxime esters, tetramethylthiuram monosulfide, and thioxanthones. Further, the use of a mixture of the photopolymerization initiator with a photosensitizer is preferred. Specific examples thereof include n-butylamine, triethylamine, and poly-n-butylphosphine.

b) Solvent Drying Type Resin

Main solvent drying type resins usable as a mixture with the ionizing radiation curing resin are thermoplastic resins which are commonly described and used in the art. The addition of the solvent drying type resin can effectively prevent defects of coating of the coated face.

In a preferred embodiment of the present invention, when the material for the substrate is a cellulosic resin such as TAC, specific examples of preferred thermoplastic resins include cellulosic resins, for example, nitrocellulose, acetylcellulose, cellulose acetate propionate, and ethylhydroxyethylcellulose. The use of the cellulosic resin can improve the adhesion between the substrate and the antistatic layer and the transparency.

c) Heat Curable Resins

Specific examples of heat curable resins include phenolic resins, urea resins, diallyl phthalate resins, melamine resins, guanamine resins, unsaturated polyester resins, polyurethane resins, epoxy resins, aminoalkyd resins, melamine-urea co-condensed resins, silicone resins, and polysiloxane resins. When heat curable resins are used, if necessary, crosslinking agents, curing agents such as polymerization initiators, polymerization accelerators, solvents, viscosity modifiers and the like may be further added.

Formation of Antistatic Layer

When the coating is formed as the antistatic layer, a liquid composition containing a mixture of the curing resin with the electrically conductive fine particles can be coated by a coating method such as roll coating, Mayer-bar coating, or gravure coating. After coating of the liquid composition, drying and ultraviolet curing are carried out.

The ionizing radiation curing resin composition is cured by irradiation with an electron beam or ultraviolet light. In the case of electron bean curing, for example, electron beams having an energy of 100 to 300 KeV are used. On the other hand, in the case of ultraviolet curing, for example, ultraviolet light emitted from light sources such as ultrahigh pressure mercury lamps, high pressure mercury lamps, low pressure mercury lamps, carbon arc, xenon arc, and metal halide lamps, are utilized.

Antireflection Film

According to another aspect of the present invention, there is provided an antireflection film. The antireflection film comprises a low-refractive index layer provided on the antiglare layer in the above antiglare film according to the present invention.

Low-Refractive Index Layer

The low-refractive index layer is formed on a surface, preferably on the outermost surface of the antiglare layer. The low-refractive index layer is different from the antiglare layer in refractive index. Preferably, the refractive index of the low-refractive index layer is lower than that of the antiglare layer. In a preferred embodiment of the present invention, the antiglare layer has a refractive index of not less than 1.5, and the refractive index of the low-refractive index layer is less than 1.5, preferably not more than 1.45.

The thickness of the low-refractive index layer is not less than 20 nm and not more than 800 nm. Preferably, the upper limit of the thickness is 400 nm, and the lower limit of the thickness is 50 nm.

A preferred embodiment of the antireflection film according to the present invention comprises a substrate and an antistatic layer (the refractive index thereof being not more than that of the antiglare layer), an antiglare layer (refractive index: not less than 1.50), and a low-refractive index layer (refractive index: less than 1.5). Since the antireflection film is in contact with an air layer (refractive index: 1.0), the reflection can be efficiently prevented. In particular, the effect of preventing reflection attained by stacking the low-refractive index layer having a lower refractive index than the refractive index of the antiglare layer can be enhanced.

1) Material for Low-Refractive Index Layer

Specific examples of the material for constituting the low-refractive index layer include silicone-containing vinylidene fluoride copolymers. An example thereof is a resin composition comprising: 100 parts by weight of a fluorine-containing copolymer having a fluorine content of 60 to 70% by weight prepared by copolymerizing a monomer composition containing 30 to 90% by weight of vinylidene fluoride and 5 to 50% by weight of hexafluoropropylene; and 80 to 150 parts by weight of a polymerizable compound containing an ethylenically unsaturated group.

An example of the fluorine-containing copolymer is a copolymer prepared by copolymerizing a monomer composition containing vinylidene fluoride and hexafluoropropylene. The content of vinylidene fluoride and the content of hexafluoropropylene in this monomer composition are 30 to 90% by weight, preferably 40 to 80% by weight, particularly preferably 40 to 70% by weight, and 5 to 50% by weight, preferably 10 to 50% by weight, particularly preferably 15 to 45% by weight, respectively. This monomer composition may further contain 0 to 40% by weight, preferably 0 to 35% by weight, particularly preferably 10 to 30% by weight of tetrafluoroethylene.

The monomer composition for preparing the fluorine-containing copolymer may if necessary contain, for example, not more than 20% by weight, preferably not more than 10% by weight, of other comonomer component. Specific examples of other comonomer components include fluorine atom-containing polymerizable monomers such as fluoroethylene, trifluoroethylene, chlorotrifluoroethylene, 1,2-dichloro-1,2-difluoroethylene, 2-bromo-3,3,3-trifluoroethylene, 3-bromo-3,3-difluoropropylene, 3,3,3-trifluoropropylene, 1,1,2-trichloro-3,3,3-trifluoropropylene, and α-trifluoromethacrylic acid.

The content of the fluorine in the fluorine-containing copolymer obtained from the above monomer composition is preferably 60 to 70% by weight, more preferably 62 to 70% by weight, particularly preferably 64 to 68% by weight. When the fluorine content is in the above-defined range, the solubility of the fluorine-containing copolymer in solvents which will be described later is high. Further, when the fluorine-containing copolymer is contained as a component, a thin film having excellent adhesion, high transparency, low refractive index, and excellent mechanical strength can be formed.

The molecular weight of the fluorine-containing copolymer is preferably 5000 to 200000, particularly preferably 10000 to 100000, in terms of number average molecular weight as determined using polystyrene as a standard. When the fluorine-containing copolymer having the above molecular weight is used, the resultant fluororesin composition becomes a suitable viscosity value and thus surely has suitable coatability.

The refractive index of the fluorine-containing copolymer per se is not more than 1.45, preferably not more than 1.42, more preferably not more than 1.40. When the refractive index is in the above-defined range, the formed thin film has favorable antireflection effect.

2) Formation of Low-Refractive Index Layer

The antireflection film according to the present invention comprises a substrate, an antiglare layer, and a low-refractive index layer. The substrate, the antiglare layer, and optionally the antistatic layer may be formed in the same manner as described above in connection with the antiglare film according to the present invention. The low-refractive index layer may be formed as follows.

A coating may be formed by exposing the fluorine-containing copolymer and the resin to an actinic radiation optionally in the presence of a photopolymerization initiator to perform polymerization, or by heating the fluorine-containing copolymer and the resin in the presence of a thermal polymerization initiator to perform polymerization. In this case, the same resins as that described above in connection with the antistatic layer may be used. Among these resins, dipentaerythritol hexa(meth)acrylate, pentaerythritol tetra(meth)acrylate, dipentaerythritol penta(meth)acrylate, and caprolactone-modified dipentaerythritol hexa(meth)acrylate are preferred.

When the resin used contains three or more ethylenically unsaturated groups per molecule, in particular, the resultant fluororesin composition can form a thin film that are very good in mechanical properties such as adhesion to the substrate and scratch resistance of the surface of the substrate.

The amount of the resin added is 30 to 150 parts by weight, preferably 35 to 100 parts by weight, particularly preferably 40 to 70 parts by weight, based on 100 parts by weight of the fluorine-containing copolymer. Further, the content of the fluorine based on the total content of polymer forming components including the fluorine-containing copolymer and the resin is 30 to 55% by weight, preferably 35 to 50% by weight.

When the addition amount or the fluorine content is in the above-defined range, the low-refractive index layer has good adhesion to the substrate and can exhibit good antireflection effect by virtue of high refractive index.

In forming the low-refractive index layer, if necessary, a suitable solvent may be used to modify the viscosity to a value which provides favorable coatability as a resin composition, that is, a value in the range of 0.5 to 5 cps (25° C.), preferably 0.7 to 3 cps (25° C.). In this case, an antireflection film having an excellent capability of reflecting visible light can be realized, and a thin film which is even, that is, free from uneven coating, can be formed. Further, a low-refractive index layer which is particularly excellent in adhesion to the substrate can be formed.

Means for curing the resin may be the same as that described above in connection with the antistatic layer. When heating means is used for the curing treatment, preferably, a thermal polymerization initiator which, upon heating, generates, e.g., radicals to initiate polymerization of the polymerizable compound is added to the fluororesin composition.

The low-refractive index layer may also be formed by other conventional thin film forming means, for example, vacuum deposition, sputtering, reactive sputtering, ion plating, electroplating or other suitable means. For example, a coating of an antireflection coating material other than the above material, an about 0.1 μm-thick very thin film or metal deposited film of MgF₂ or the like, or a deposited film of SiOx or MgF₂ may be formed as the low-refractive index layer.

Polarizing Plate and Image Display Device

According to still another aspect of the present invention, there is provided a polarizing plate comprising: a polarizing element; and an antireflection film. In the polarizing plate, the antireflection film according to the present invention is provided on a surface of the polarizing element. According to a further aspect of the present invention, there is provided an image display device. This image display device comprises: a transmission display; and a light source device for illuminating said transmission display from the backside thereof, wherein the antiglare film according to the present invention, the antireflection film according to the present invention, or the polarizing plate according to the present invention is provided on a surface of said transmission display.

1) Polarizing Plate

In the present invention, a polarizing plate having improved antireflection properties can be provided by laminating the antireflection film according to the present invention onto a polarizing element. For example, polyvinyl alcohol films, polyvinyl formal films, polyvinyl acetal films, and ethylene-vinyl acetate copolymer saponified films, which have been dyed with iodine or a dye and stretched, may be used as the polarizing element. In the lamination, for adhesion enhancement or antistatic purposes, the substrate (preferably triacetylcellulose films) in the antireflection film is preferably subjected to saponification.

In the polarizing plate according to the present invention, for example, the polarizing element and the antireflection film according to the present invention may be provided in that order from the backlight side. In another embodiment, the polarizing plate may be such that the antireflection film according to the present invention may be provided on both sides of the polarizing element.

2) Image Display Device

The image display device according to the present invention basically comprises a light source device (backlight), a display element, and the antiglare film according to the present invention. Preferably, the image display device comprises a light source device, a display element, and the antireflection film according to the present invention (more preferably the polarizing plate according to the present invention). An embodiment of the image display device according to the present invention comprises a light source device, a polarizing element, a substrate, an image display element, a substrate, a polarizing plate (preferably one according to the present invention), and an antireflection film (preferably one according to the present invention) provided in that order from the backlight side.

When the image display device according to the present invention is a liquid crystal display device, light from the light source in the light source device is applied from the lower side of the antireflection film. In the case of an STN-type liquid crystal display device, a phase difference plate may be inserted into between the liquid crystal display element and the polarizing plate. In this liquid crystal display device, if necessary, an adhesive layer may be provided between the individual layers.

Applications

The antiglare film, the antireflection film, the polarizing plate, and the image display device according to the present invention are usable in transmission display devices. In particular, they can be used in displays such as televisions, computers, word processors and the like, especially on the surface of displays for high definition images, such as CRTs and liquid crystal panels.

### EXAMPLES

The following Example further illustrates the contents of the present invention. The present invention, however, is not to be construed as being limited thereto.

### Example 1

A composition specified in the following composition table was prepared by thorough mixing and was filtered through a polypropylene filter with a pore diameter of 30 μm to prepare coating liquid 1. An 80 μm-thick triacetylcellulose film (TAC; TD 80U: manufactured by Fuji Photo Film Co., Ltd.) in a roll form was unwound, and coating liquid 1 for an antiglare layer prepared above was coated onto the film to a thickness of 7 μm on a dry basis. The coated film was heated at 110° C. for one min and was then further irradiated with ultraviolet light at 55 mJ under a nitrogen purge (oxygen concentration: not more than 200 ppm) to photocure the coating and thus to form an antiglare layer. Thus, an antiglare film was prepared.

Coating liquid 1

| | | |
|---|---|---|
| Pentaerythritol triacrylate (PETA, | 55 | parts by mass |
| manufactured by Nippon Kayaku Co., Ltd.) | | |
| Isocyanurate ethoxy-modified diacrylate | 45 | parts by mass |
| of formula (I) (M-215, manufactured by Toa | | |
| Gosei Chemical Industry Co., Ltd.) | | |
| Acrylic polymer (manufactured by Mitsubishi | 10 | parts by mass |
| Rayon Co., Ltd.; MW = 75000) | | |
| Photocuring initiator (Irgacure 184, | 5 | parts by mass |
| manufactured by Ciba-Geigy) | | |
| Acryl-styrene beads (manufactured by Soken | 3 | parts by mass |
| Chemical & Engineering Co., Ltd.; particle | | |
| diameter 3.5 μm, n = 1.55) | | |
| Styrene beads (manufactured by Soken | 12 | parts by mass |
| Chemical & Engineering Co., Ltd.; particle | | |
| diameter 3.5 μm, n = 1.60) | | |
| Siloxane leveling agent (10-28, | 0.05 | part by mass |
| manufactured by Dainichiseika Color & | | |
| Chemicals Manufacturing Co., Ltd.) | | |
| Toluene | 140 | parts by mass |
| Cyclohexanone | 60 | parts by mass |

### Comparative Example 1

An antiglare film was prepared in the same manner as in Example 1, except that coating liquid 2 was prepared using a composition specified in the following composition table.

Coating liquid 2

| | | |
|---|---|---|
| Pentaerythritol triacrylate (PETA, | 95 | parts by mass |
| manufactured by Nippon Kayaku Co., Ltd.) | | |
| Dipentaerythritol pentaacrylate/ | 5 | parts by mass |
| dipentaerythritol hexaacrylate mixture (DPHA, | | |
| manufactured by Nippon Kayaku Co., Ltd.) | | |
| Acrylic polymer (manufactured by Mitsubishi | 10 | parts by mass |
| Rayon Co., Ltd.; MW = 75000) | | |
| Photocuring initiator (Irgacure 184, | 5 | parts by mass |
| manufactured by Ciba-Geigy) | | |
| Acryl-styrene beads (manufactured by Soken | 3 | parts by mass |
| Chemical & Engineering Co., Ltd.; particle | | |
| diameter 3.5 μm, n = 1.55) | | |
| Styrene beads (manufactured by Soken | 12 | parts by mass |
| Chemical & Engineering Co., Ltd.; particle | | |
| diameter 3.5 μm, n = 1.60) | | |
| Siloxane leveling agent (10-28, | 0.05 | part by mass |
| manufactured by Dainichiseika Color & | | |
| Chemicals Manufacturing Co., Ltd.) | | |
| Toluene | 140 | parts by mass |
| Cyclohexanone | 60 | parts by mass |

### Comparative Example 2

An antiglare film was prepared in the same manner as in Example 1, except that coating liquid 3 was prepared using a composition specified in the following composition table.

Coating liquid 3

| | | |
|---|---|---|
| Pentaerythritol triacrylate (PETA, | 95 | parts by mass |
| manufactured by Nippon Kayaku Co., Ltd.) | | |
| 1,6-Hexanediol diacrylate (HDDA, | 5 | parts by mass |
| manufactured by Nippon Kayaku Co., Ltd.) | | |
| Acrylic polymer (manufactured by Mitsubishi | 10 | parts by mass |
| Rayon Co., Ltd.; MW = 75000) | | |
| Photocuring initiator (Irgacure 184, | 5 | parts by mass |
| manufactured by Ciba-Geigy) | | |
| Acryl-styrene beads (manufactured by Soken | 3 | parts by mass |
| Chemical & Engineering Co., Ltd.; particle | | |
| diameter 3.5 μm, n = 1.55) | | |
| Styrene beads (manufactured by Soken | 12 | parts by mass |
| Chemical & Engineering Co., Ltd.; particle | | |
| diameter 3.5 μm, n = 1.60) | | |
| Siloxane leveling agent (10-28, | 0.05 | part by mass |
| manufactured by Dainichiseika Color & | | |
| Chemicals Manufacturing Co., Ltd.) | | |
| Toluene | 140 | parts by mass |
| Cyclohexanone | 60 | parts by mass |

Evaluation Test

The antiglare films of Example 1 and Comparative Examples 1 and 2 prepared above were subjected to the following evaluation tests. The results were as shown in Table 1 below.

Evaluation 1: Test on Occurrence of Curling

The antiglare film was cut into a size of 10 cm×10 cm, and the maximum curling width (along FIG. 1) was measured. In this case, the antiglare film was placed in an environment of temperature 25° C. and humidity 55% for the measurement.

Evaluation 2: Test on Degree of Adhesion of Coating

The antiglare film only on its antiglare layer face was cut with a cutter knife to form 100 cross-cuts (10 cross-cuts in longitudinal direction×10 cross-cuts in transverse direction=100 cross-cuts). Next, for specimens having a size of 2.5 cm×2.5 cm, cross-cut Cello-Tape (manufactured by Nichiban Co., Ltd.: cellophane adhesive tape) was rapidly attached and detached. This procedure was repeated five times, and the degree of adhesion of coating was expressed in m/100 wherein m represents the number of squares remaining unremoved among the 100 squares.

Evaluation 3: Measurement of Total Light Transmittance and Haze

The antiglare film was measured for the total light transmittance and haze with a reflectometer/transmissometer HR-100 (Murakami Color Research Laboratory).

Evaluation 4: Test on Strength

A pencil was pressed against the antiglare film under a load of 9.8 N, and the strength of the antiglare film was evaluated in terms of the hardness of the pencil.

Evaluation 5: Scratch Resistance Test

A load of 4.9 N×2 was applied by a truck wheel CS-10F (manufactured by TABER INDUSTRIES) to the antiglare film by rotating the truck wheel by 100 turns. A difference in haze between before and after 100-turn rotation of the truck wheel was then determined.

TABLE 1

| | | Comparative | Comparative |
|---|---|---|---|
| | Example 1 | Example 1 | Example 2 |
| Curling (mm) | 7 | Immeasurable | Immeasurable |
| Degree of adhesion of | 100/100 | 100/100 | 100/100 |
| coating | | | |
| Total light | 92.0 | 91.9 | 92.0 |
| transmittance (%) | | | |
| Haze (%) | 0.3 | 0.2 | 0.2 |
| Pencil hardness | H | H | B |
| Scratch resistance test | 7.6 | 6.8 | 6.0 |

1. An antiglare film comprising: a substrate; and an antiglare layer provided on said substrate,
said antiglare layer comprising fine particles and two or more polyfunctional acrylic resins,
at least one of said two or more polyfunctional acrylic resins being isocyanurate ethoxy-modified diacrylate represented by formula (I):

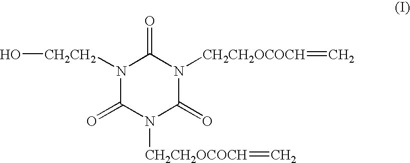

2. The antiglare film according to claim 1, wherein said polyfunctional acrylic resin other than said isocyanurate ethoxy-modified diacrylate is pentaerythritol triacrylate.

3. The antiglare film according to claim 1, wherein the difference in thickness between the center part and the peripheral part in the antiglare layer is not more than 1.0 μm.

4. The antiglare film according to claim 1, wherein the amount of said isocyanurate ethoxy-modified diacrylate added is not less than 10% by weight and not more than 45% by weight based on the total amount of said polyfunctional acrylic resin.

5. The antiglare film according to claim 1, wherein
an antistatic layer is provided between said substrate and said antiglare layer, and
said antistatic layer comprises a curing resin and an electrically conductive material.

6. The antiglare film according to claim 5, wherein said antiglare layer further comprises electrically conductive fine particles to impart electrical conductivity to a part between the outermost surface layer in the said antiglare layer and said antistatic layer.

7. An antireflection film comprising said substrate and said antiglare layer of claim 1, and a low refractive index layer provided on said antiglare layer, wherein said low-refractive index layer has a lower refractive index than said antiglare layer.

8. A polarizing plate comprising a polarizing element and said antireflection film according to claim 7 provided on the surface of said polarizing plate.

9. An image display device comprising a transmission display, a light source device for illuminating said transmission display from the backside thereof, and said antiglare film according to claim 1 provided on a surface of said transmission display.

10. An image display device comprising a transmission display, a light source device for illuminating said transmission display from the backside thereof, and said antireflection film according to claim 7 provided on a surface of said transmission display.

11. An image display device comprising a transmission display, a light source device for illuminating said transmission display from the backside thereof, and said polarizing plate according to claim 8 provided on a surface of said transmission display.
